(19) United States
(12) Patent Application Publication
(10) Pub. No.: US 2005/0092154 A1
(43) Pub. Date: May 5, 2005

(54) Cutter apparatus for flat plate building material

(76) Inventor: Masato Higuchi, Tokyo (JP)

Correspondence Address: Geoffrey R. Myers, Esquire;Hall, Priddy, Myers & Vande Sande, Ste. 200, 10220 River Road, Potomac, MD, 20854, US

(21) Appl. No.: 10/730,987

(22) Filed: Dec. 10, 2003

(30) Foreign Application Priority Data
Oct. 30, 2003 (JP) 2003-371012

(51) Int. Cl. B26D 5/08; B26D 1/14

(52) U.S. Cl. 83/523; 83/471.3

(57) ABSTRACT

A cutter apparatus for a flat plate building material according to the present invention comprises: an inclined base having a slope; a cutter having a rotary blade for cutting a slipping-down flat plate building material; and cutter fixing means for installing the rotary blade at a predetermined height from the slope, the cutter fixing means comprising: a cutter rail trained between the opposite ends of the inclined base in the direction of the width of the base; a movable support section movable along the cutter rail; and a cutter holder mounted on the movable support section for supporting a casing of the cutter.

### BACKGROUND OF THE INVENTION

1. Field of the Invention

The present invention relates to a cutter apparatus for a flat plate building material for cutting a flat plate building material such as a tile or forming a cut groove therein.

2. Description of the Related Art

There are instances where a flat plate building material such as a mosaic tile must be cut into required sizes (lateral and longitudinal sizes) upon construction. A most simplified method therefor for example serves to previously draw a cut line in a tile as a standard with a magic and the like, and then fix the tile and cut the same along the cut line by operating a disk shaped motor-driven cutter.

Existing automated tile cutters enjoy such very many constructions as disclosed in the following references 1 to 6. Many of these constructions are obtained by combining a disk shaped motor-driven cutter and tile fixing means or tile conveying means. There are for example known a system for cutting a tile by fixing the tile and moving a motor-driven cutter linearly as disclosed in the following patent references 2 and 5, and a system for cutting a tile by fixing a motor-driven cutter and moving the tile in a straight line as disclosed in the following references 1, 3, 4, and 6.

The references include: patent reference 1: Japanese Laid-Open Patent Publication No. 1995-96515; patent reference 2: Japanese Laid-Open Patent Publication No. 1995-148730; patent reference 3, Japanese Laid-Open Patent Publication 1999-19922; patent reference 4: Japanese Laid-Open Patent Publication No. 2001-277085; patent reference 5: Japanese Laid-Open Patent Publication No. 2001-287221; and patent reference 6: Japanese Laid-Open Patent Publication No. 2001-212819.

However, an existing tile cutter disclosed in the patent references 1 to 6 requires a drive mechanism for moving any of a tile or a cutter straight, so that the cost of power other than driving of a motor driven cutter is increased, and its structure is complicated. Further, when any of the tile or the cutter is moved without using any drive mechanism such as a motor-driven type, a load for work is increased. An existing tile cutter is, because of its system for fixing or horizontally moving a tile and a cutter, large-sized as a whole and occupies a wide installation space. Since it is necessary to process flat plate building materials such as several tens or several hundreds of tiles depending upon the details of construction, there is required with a reduced load for work a cutter capable of achieving work as rapidly and simply as possible.

### SUMMARY OF THE INVENTION

In view of the drawbacks with the prior art, it is an object of the present invention to provide a compact cutter apparatus for a flat plate building material capable of cutting a flat plate building material rapidly and securely into an arbitrary size without requiring power and a drive mechanism for moving a flat plate building material such as a tile or a cutter. It is another object of the present invention to provide a cutter apparatus for a flat plate building material with a reduced load for work being capable of easy use. To achieve the above objects, the present invention provides the following construction:

(1) A cutter apparatus for a flat plate building material in accordance with claim 1 is provided, in which it comprises an inclined base having a slope; a cutter including a rotatable blade for cutting a flat plate building material slipping down on the slope; and cutter fixing means for fixing said cutter to dispose said rotary blade at a predetermined height from said slope.

(2) A cutter apparatus for a flat plate building material in accordance with claim 2 is provided, in which in claim 1 the cutter fixing means comprises a cutter rail trained around opposite ends of the slope perpendicularly to the direction of the inclination of said slope; a movable supporter movable along the cutter rail; and a cutter holder mounted on the movable supporter for supporting a casing of the aforementioned cutter.

(3) A cutter apparatus for a flat plate building material in accordance with claim 2 is provided, in which the cutter rail includes a rail groove, and the movable support section includes a fitting portion having a shape fitting to the rail groove.

(4) A cutter apparatus for a flat plate building material in accordance with claim 2 is provided, in which the foregoing cutter rail includes a pair of rail rods, and said movable support portion includes a fitting portion having a pair of holes through which said pair of the rail rods pass.

(5) A cutter apparatus for a flat plate building material in accordance with any of claims 2 is provided, in which it includes means for adjusting the mounting position of said cutter holder with respect to the movable support portion to change the height of the rotary blade from the slope.

(6) A cutter apparatus for a flat plate building material in accordance with claim 5 is provided, in which it includes a side stopper extending between opposite ends of the foregoing slope in parallel to the direction of the inclination to bring the side stopper into contact with the side surface of the foregoing slipping-down flat plate building material.

(7) A cutter apparatus for a flat plate building material in accordance with claim 6 is provided, in which the side stopper is movable perpendicularly to the direction of said inclination.

(8) A cutter apparatus for a flat plate building material in accordance with any of claims 2 to 7 is provided, in which there is provided a slit extending in the direction of the foregoing inclination on the slope of the foregoing inclined base to receive a folded portion when the flat plate building material has the folded portion.

(9) A cutter apparatus for a flat plate building material in accordance with any of claims 2 to 8 is provided, in which there is provided a second inclination to permit one side of the inclined base to be lower than the other side of the same in the direction perpendicular to the direction of the inclination of the slope.

(10) A cutter apparatus for a flat plate building material in accordance with g to any of claims 2 to 9 is provided, in which there is further provided means for adjusting an angle of the face of the rotary blade with respect to said inclination surface.

In accordance with a cutter apparatus for a flat plate building material of the present invention, the flat plate building material such as a tile thrown from the upper end of the slope is cut with the cutter in the course of its slipping-down on the slope following the force of gravity and falls down to the lower end of the slope as it is by fixing the cutter halfway the slope.

In the present cutter, a cutter apparatus for a flat plate building material is cut in the course of natural falling by making use of the force of gravity, so that there is eliminated the need of a drive mechanism and power for conveying the flat plate building material and the cutter excepting the driving for the rotary blade of the cutter.

Further since it employs the inclined base as a working base, an occupation space (installation space) can be more sharply reduced, compared with a prior art tile cutter employing a horizontal base as such a working base.

Since in the present cutter apparatus a worker may simply throw a flat plate building material onto the slope, and hence a cutting work is achieved rapidly and simply, it is very effective when many flat plate building materials must be cut.

Furthermore, since the cutter is movable along the cutter rail perpendicularly to the direction of the inclination , it can be fixed to the inclined base at an arbitrary position on the inclined base in the direction of the width of the same. Hereby, the cut position of the flat plate building material can be adjusted.

The cut position of the flat plate building material can be adjusted even by making movable the side stopper to bring the side of the flat plate building material into contact with the cutter blade. The side stopper also has the effect of preventing the flat plate building material from being displaced laterally.

A folded portion of a folded material does not obstruct the cutting by providing a slit for accommodating the folded portion of the folded material on the slope.

Furthermore, the flat plate building material is pushed toward the side stopper to further improve the effect of the prevention of the lateral displacement of the material by providing the second inclination such that the one side of the inclined base is lower than the other side of the same in the direction perpendicular to the direction of the inclination of the slope.

### BRIEF DESCRIPTION OF THE DRAWINGS

FIG. 1 is a side view illustrating an external appearance of an embodiment of a cutter apparatus for a flat plate building material according to the present invention;

FIG. 2 is a perspective view illustrating the cutter apparatus for a flat plate building material taken along an arrow X1 in FIG. 1;

FIG. 3 is a partial view illustrating the vicinity of a cutter rail in the embodiment shown in FIGS. 1 and 2 with (A) a partial view of an inclined base as viewed frontally of the same, and (B) a cross sectional view taken along a line X2-X2 in (A), and (C) a cross sectional view taken along a line X3-X3;

FIG. 4 is a view illustrating another embodiment of the cutter rail with (A) a partial view of the inclined base 12 as viewed frontally of the same, and (B) a cross sectional view taken along a line X4-X4 in (A), and (C) a cross sectional view taken along a line X5-X5 in (A);

FIGS. 5(A) to (C) are views illustrating an embodiment of mounting position adjusting means for adjusting the height of the cutter blade of the cutter from a slope of the inclined base;

FIG. 6 is a view illustrating another embodiment of the inclined base of the cutter apparatus for a flat plate building material according to the present invention with (A) a plan view illustrating the inclined base, and (B) a cross sectional view taken along a line X6-X6 in (A);

FIG. 7 is a view illustrating further another embodiment of the inclined base of the cutter apparatus for a flat plate building material according to the present invention, with (A) being a plan view of the inclined base and (B) being a cross sectional view taken along a line X7-X7 in (A); and

FIG. 8 is a view illustrating an embodiment associated with a method of the disposition of the cutter blade of the cutter apparatus for a flat plate building material according to the present invention.

### DETAILED DESCRIPTION OF THE PREFERRED EMBODIMENTS

In what follows, preferred embodiments of a cutter apparatus for a flat plate building material according to the present invention will be described with reference to the accompanying drawings. It is noted that the mention of “A flat plate building material is cut.” in the present specification should be interpreted in a wide meaning, and it includes both of the case of a flat plate building material being completely cut away, and of the case of a flat plate building material where it is not completely cut away and only a cut groove is formed. Once the cut groove is formed, it is possible to cut a flat plate building material simply along the cut groove in a work thereafter. Further, a typical flat plate building material includes a ceramic tile, and flat plates formed from various materials such as stone materials, bricks, and the like.

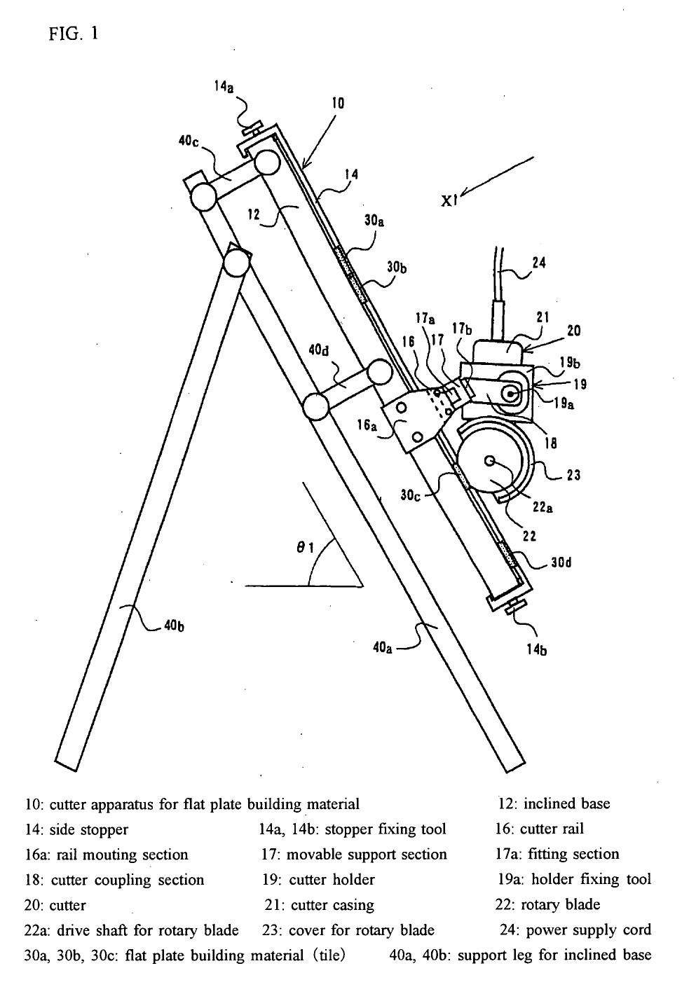

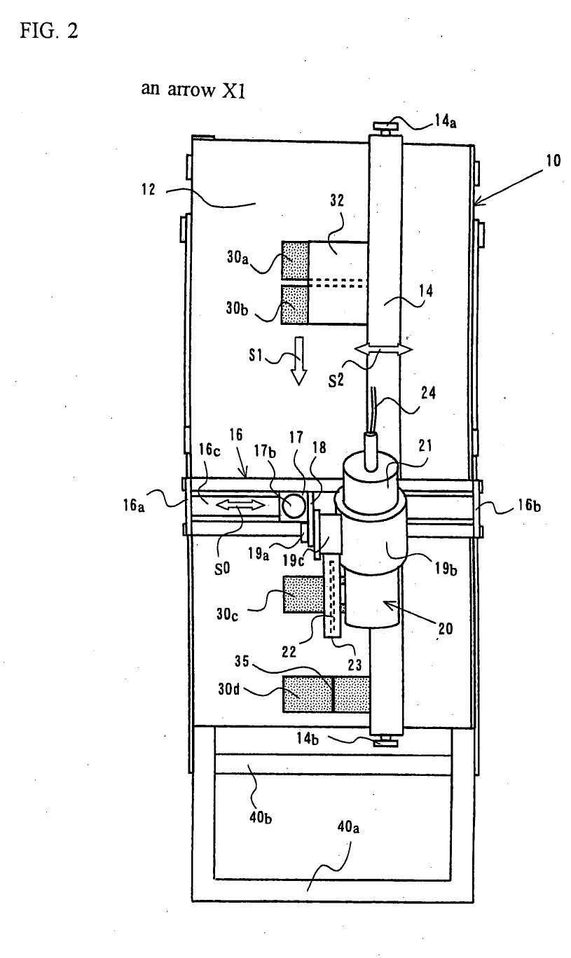

Referring to FIG. 1, an external appearance of a preferred embodiment of a cutter apparatus for a flat plate building material according to the present invention is illustrated in a side view. Referring further to FIG. 2, a perspective view of the flat plate building material taken along an arrow X1 in FIG. 1 is provided. Hereinafter, there will be described the case of the flat plate building material being a tile.

The cutter apparatus for a flat plate building material 10 includes an inclined base 12 having a slope; a cutter having a rotary blade 22 for cutting tiles 30a to 30d slipping down on the slope; and cutter fixing means for fixing the cutter 20 to install the rotary blade 22 at a predetermined height from the slope. An angle of the inclination of the slope is indicated by □1.

For safety a rotary blade cover 23 is provided to cover the rotary blade 22. A motor and the like are contained in a casing 21 of the cutter 21. A power supply cord 24 extends from the rear end of the casing 21 of the cutter 20, and is connected with a commercial power supply.

In the embodiments illustrated in FIGS. 1, 2 the cutter fixing means comprises a plurality of members. There is first provided a cutter rail 16 trained between opposite ends of an inclined base 12 perpendicularly to the direction of the inclination of the slope. Rail mounting sections 16a, 16b of the opposite ends of the cutter rail 16 are fixed to opposite ends of the inclined base 12 in the direction of the width thereof. There is a gap between the cutter rail 16 and the slope. The size of the gap is more increased than the thickness of the object tile 30a such that there is no trouble when the tile 30a and the like pass through below the cutter rail 16. A movable support section 17 mounted on the cutter rail 16 is movable over the whole of the width of the inclined base along the cutter rail 16 as indicated by an arrow S0. The movable support section 17 can be fixed to the cutter rail 16 by clamping a fixing tool 17a while selecting a predetermined position. In contrast, a cutter holder 19 is mounted on the movable support section 17 for supporting the cutter 20. In the present embodiment, a flat plate-shaped cutter coupling section 18 extends from the side surface of the movable support section 17, and the cutter holder 19 is mounted at the tip end of the cutter coupling section 18 with the aid of a holder fixing tool 19a such as a bolt and the like. The cutter holder 19 includes a cylinder section 19b surrounding the casing 21 of the cutter 20, and a protrusion 19c protruding from a part of the cylinder section 19b. The protrusion 19c is mounted on the cutter coupling section 18 with the aid of the holder fixing tool 19a. However, the configuration of the cutter holder is not limited to the present embodiment. The configuration may be one where it can move integrally with the movable support section 17 to support the cutter 20 at a predetermined position.

In the cutter apparatus for a flat plate building material 10 with such a construction when a tile 30a and the like are thrown along the slope from the upper end of the same, the thrown tile 30a and the like slip down in the direction of the inclination owing to gravity as indicated by an arrow S1. The rotary blade 22 of the cutter 20 installed at a proper position cuts the tile 30a and the like slipping down. The cut tile 30a and the like slip down on the slope as they are, and are sent from a lower end of the slope. For containing the tile 33a falling down from the lower end of the slope it is preferable to dispose a proper container. In such a manner, the tile 30a passes through between the inclined base 12 and the cutter rail 16, and a cut groove 35 is formed with the aid of the rotary blade 22 as shown in a tile 30d.

As illustrated in FIGS. 1 and 2, there is preferably provided a side stopper 14 extending between the opposite ends of the slope in a direction parallel to the direction of the inclination of the inclined base 12. It is possible to keep a cut position unchanged by bringing the one side of the slipping down tile 30a into contact with the side stopper 14 to prevent the tile from being displaced laterally. The side stopper 14 is installed to pass through a gap between the slope and the cutter rail 16. The thickness of the side stopper 14 is properly determined in response to the thickness of the tile 30a in order to bring the side of the tile 30a into contact with the side stopper 14 for stabilization. As indicated by an arrow S2 the side stopper 14 is further preferably movable in the direction perpendicular to the direction of the inclination of the side stopper 14. The cut position of the tile 30a is adjustable in such a manner also by moving the side stopper 14.

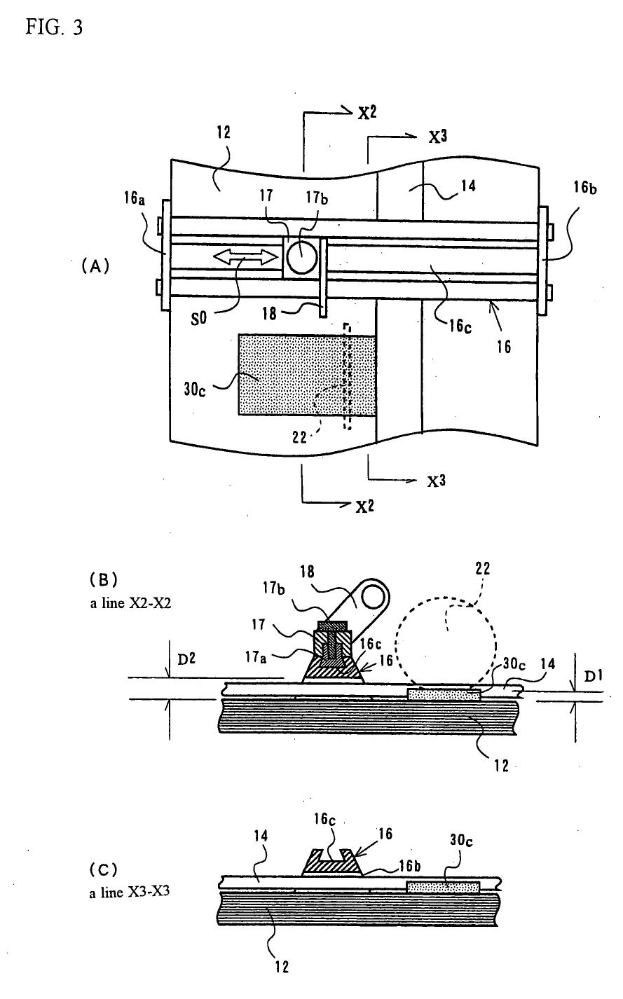

Referring then to FIG. 3, a partial view illustrating the neighbourhood of the cutter rail 16 in the embodiment illustrated in FIGS. 1 and 2 is provided. FIG. 3 is a partial view when the inclined base 12 is viewed frontally thereof. The illustration of the cutter holder and the cutter mounted on the cutter coupling section 18 is neglected. As the movable support section 17 moves left and right along the cutter rail 16 as indicated by the arrow S0, the position of the rotary blade 22 also shifts. Hereby, the position of the cut groove formed in the tile 30c is changed.

FIG. 3(B) is a cross sectional view taken along a line X2-X2 in FIG. 3(A), and FIG. 3(C) is a cross sectional view taken along a line X3-X3 in FIG. 3(A). In FIG. 3(B), D1 signifies the thickness of the tile 30c, and D2 signifies the size of the gap between the slope of the inclined base 12 and the cutter rail 16. D2 is larger than D1, and the side stopper 14 passes through the gap with the size D2. The configuration of an upper half of the movable support section 17 may be defined arbitrarily, provided that the cutter 20 can be directly or indirectly mounted and supported. A fitting section 17a having a trapezoidal cross sectional configuration is protruded from the lower surface of the movable support section 17. This fits to the rail groove 16c having the same cross sectional configuration, whereby the movable support section 17 can smoothly move laterally without slipping upward. Describing the movement of the tile 30c with reference to FIGS. 3(B) and 3(C), the tile 30c slides from the left while making contact with the side stopper 14 and passes through below the cutter rail, and is thereafter cut by the rotary blade 22 and is further moved to the right.

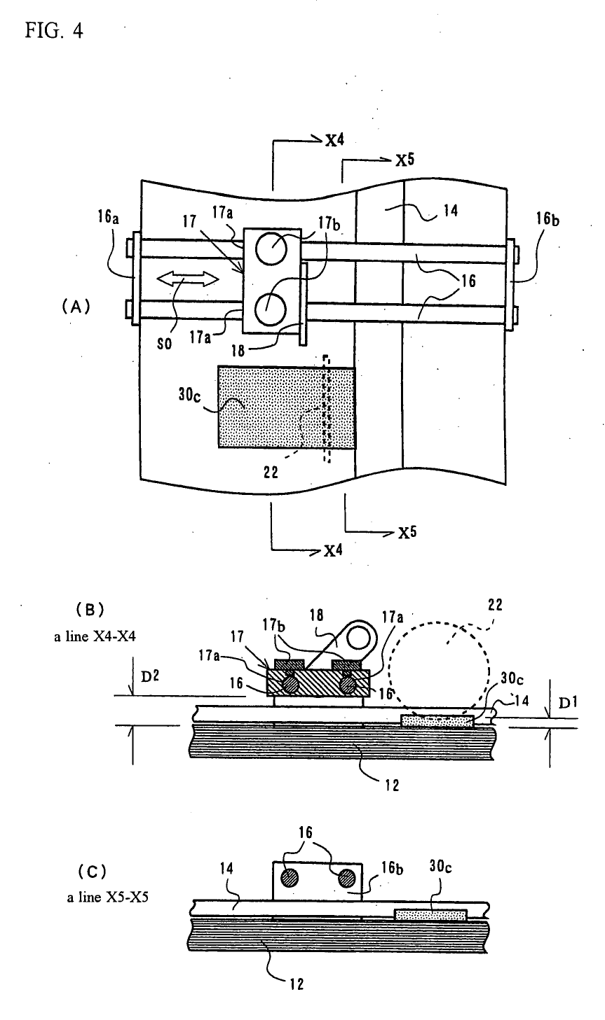

Referring to FIG. 4, a view illustrating another embodiment of the cutter rail 16 is provided. There shall be applied the same symbols as those corresponding to the components in the embodiment in FIG. 3. Although FIG. 4(A) is a partial view when the inclined base 12 is viewed frontally, the illustration of the cutter holder mounted on the cutter coupling section 18 and the cutter is neglected, and the position of the rotary blade 22 is indicated with a broken line. In the embodiment illustrated in FIG. 4, the cutter rail 16 is formed by training a pair of rod shaped rail rods between the opposite ends of the inclined base. In the movable support section 17 there is formed the fitting section 17a composed of a pair of holes through which the pair of the rail rods 16 pass. Also in the present embodiment, the position of the rotary blade moves left and right as the movable support section 17 moves left and right along the rail rod 16 as indicated by the arrow S0. Further, the movable support section 17 is fixed to the rail rod 16 by clamping the pair of the movable support section fixing tools 17b respectively. The position of the cut groove formed in the tile 30c is changed by changing the position of the movable support section 17.

FIG. 4(B) is a cross sectional view taken along a line X4-X4 in FIG. 4(A), and FIG. 4(C) is a cross sectional view taken along a line X5-X5 in FIG. 4(A). In FIG. 4(B), D1 signifies the thickness of the tile 30c, and D2 signifies the size of the gap between the slope of the inclined base 12 and the cutter rail 16. D2 is larger than D1, and the side stopper 14 passes through the gap of D2. The tile 30c comes here sliding from the left while making contact with the side stopper 14, and passes below the cutter rail, and is thereafter cut with the rotary blade 22, and is further moved to the right, as in the embodiment illustrated in FIG. 3.

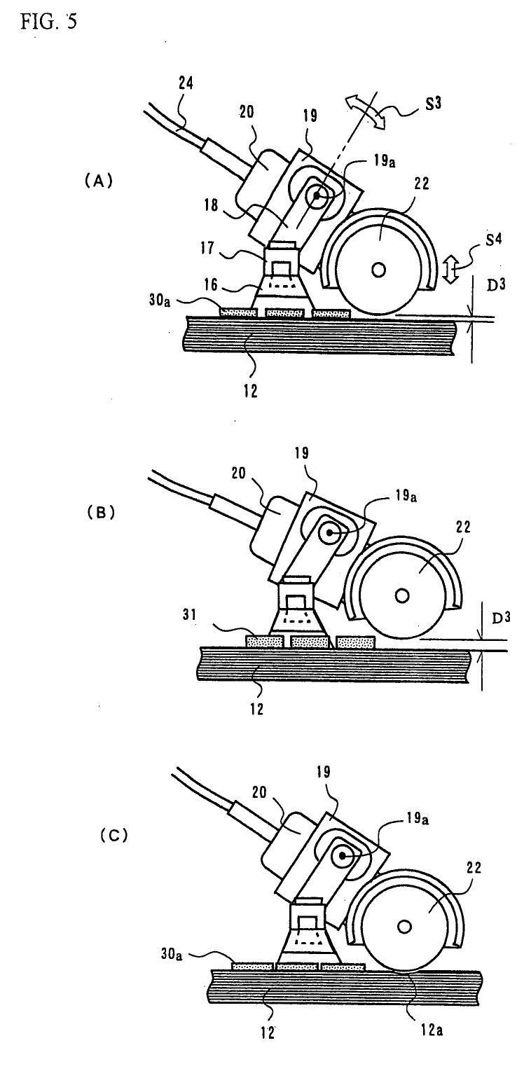

Referring to FIGS. 5(A) to (C), an example of the mounting position adjusting means for the cutter holder 19 for adjusting the height D3 of the rotary blade 22 of the cutter 20 from the slope is illustrated. In FIG. 5(A), the height of the rotary blade 22 from the slope is D3. The cutter holder 19 is mounted with the holder fixing tool 19a such that it is supported around one point on the tip end of the cutter coupling section 18 provided integrally with the movable support section 17. The holder fixing tool 19a is a clamping tool such as a bolt for example. Accordingly, once the holder fixing tool 19a is released, the cutter holder 19 can be rotated as indicated by an arrow S3 around the center of the holder fixing tool 19a as a rotation axis. Once the cutter holder 19 rotates, the position of the cutter 20 supported by the cutter holder 19, i.e., the rotary blade 22 is changed. Hereby, the height D3 of the rotary blade 22 from the slope is changed. The rotary blade can be fixed at a predetermined height by clamping the holder fixing tool 19a after the rotation position of the cutter holder 19 is determined. In FIG. 5(B), the height D3 of the rotary blade 22 from the slope is higher than that in FIG. 5(A).

The depth of the cut groove in the flat plate building material can be changed by changing the height of the rotary blade 22 from the slope as illustrated in FIG. 5. The height of the rotary blade 22 illustrated in FIG. 5(A) is that when a relatively thin tile 30a is cut, while the height in FIG. 5(B)is that when a relatively thick tile 31 is cut.

It is noted that when the tiles 30a, 31 are completely cut, it is necessary to lower the rotary blade 22 up to its position in contact with the slope or lower as illustrated in FIG. 5(C). For such a situation a groove 12a for provision of a gap between a peripheral edge of the rotary blade 22 and the inclined base may be formed over the width of the inclined base 12. However, the length of the groove 12a in the direction of the movement of the tile 30a is defined not to obstruct the smooth movement of the tile 30a (for example, hooked or falling down.).

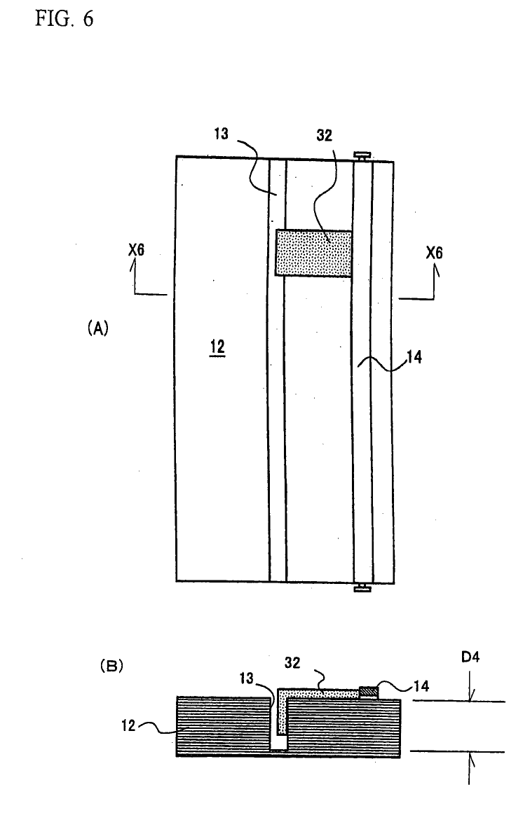

Referring to FIG. 6, a view illustrating another embodiment of the inclined base 12 of the cutter apparatus for a flat plate building material according to the present invention is illustrated. FIG. 6(A) is a plan view of the inclined base 12. The inclined base 12 in the present embodiment is one adapted to a folded material 32 such as a folded tile having a right folded portion. A slit 13 extending in the direction of the inclination is formed in the slope of the inclined base 12. The slit 13 is to receive the folded portion of the folded material 32. FIG. 6(B) is a cross sectional view taken along a line X6-X6 in FIG. 6(A). The depth D4 of the slit 13 is needed to be more lengthened than the folded portion. When the folded material 32 is cut, it is thrown into the inclined base 12 in the state where the folded portion is thrown down into the slit 13. The thrown folded material 32 slips down on the slope.

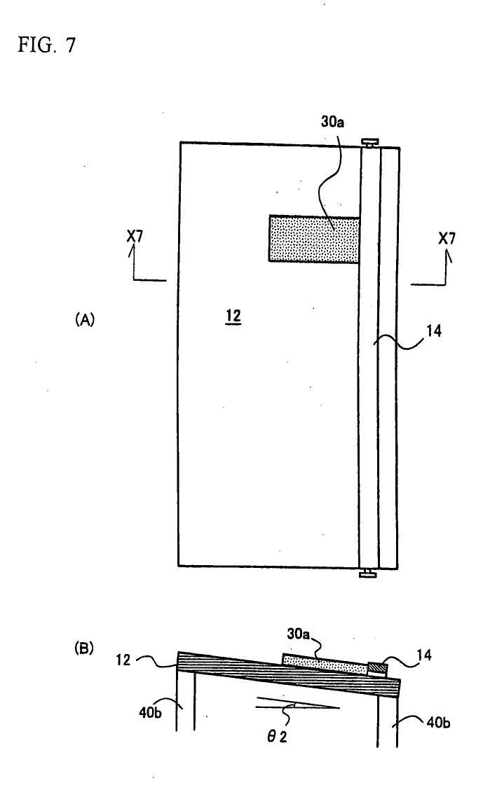

Referring to FIG. 7, a view of further another embodiment of the inclined base 12 of the cutter apparatus for a flat plate building material according to the present invention is illustrated. FIG. 7(A) is a plan view of the inclined base 12. FIG. 7(B) is a cross sectional view taken along a line X7-X7 in FIG. 7(A). In the present embodiment, there is provided a second inclination such that in the width direction of the inclined base 12 one side thereof is lower than the other side. The angle of the second inclination is indicated by □2. When the second slope is provided perpendicularly to the direction of the original inclination in such a manner, the tile 30a is brought into contact with the side stopper 14 such that it is located on a higher side of the inclination from the side stopper 14. Hereby, the tile 30a is pressed to the side stopper 14, and hence the tile 30a is further prevented from being laterally displaced. This also utilizes the force of gravity. The angle □2 of the second inclination is arbitrarily set such that the effect of the tile 30a being pressed to the side stopper 14 could be realized. It is herein noted that since the cutter rail is disposed in parallel to the slope, the cut surface of a tile by the rotary blade is kept perpendicular to the original inclination and is prevented from being oblique to the same.

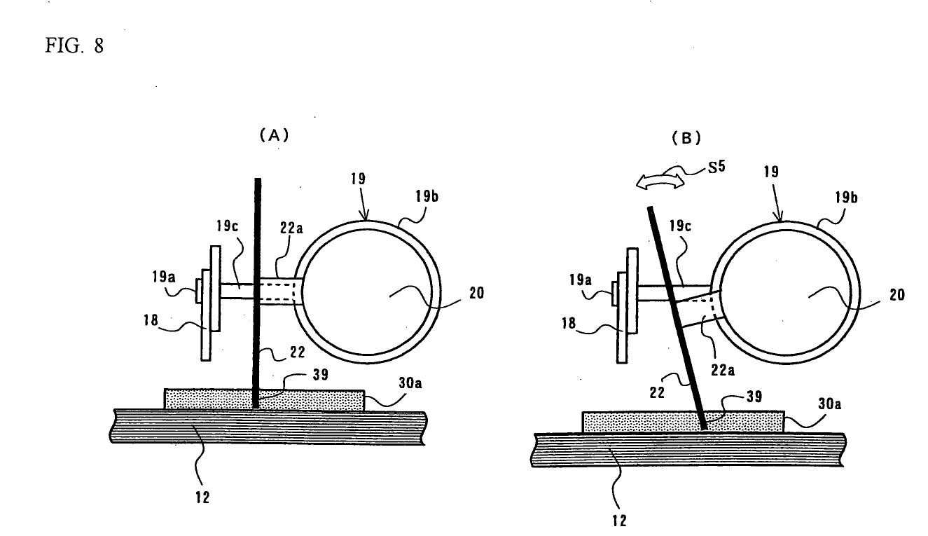

Referring to FIG. 8, an embodiment associated with angle adjustment means for the angle of the surface of the, rotary blade 22 of the cutter apparatus for a flat plate building material according to the present invention is illustrated. In FIG. 8(A), the cutter 20 is supported in a cylindrical portion 19c of the cutter holder 19 with the axis of the cylindrical portion 19c fixed in parallel to the slope of the inclined base 12. As illustrated in the same figure, the surface of the rotary blade 22 mounted on the tip end of the cutter drive shaft 22a extending from the cutter 20 is perpendicular to the slope of the inclined base 12. the cut surface 39 of the tile 30a is therefore also perpendicular to the opposite surfaces of a tile. It is herein possible to alter the angle of the rotary blade 22 with respect to the slope of the inclined base 12 as indicated by an arrow S5 in FIG. 8(B) by rotating the cylindrical cutter 20 in the cutter holder 19 around the axis thereof. FIG. 8(B) illustrates the state of the cutter 20 where the surface of the rotary blade 22 is fixed not perpendicularly to the slope but in an inclined direction. Thereupon, the tile 30a is cut not perpendicularly to the opposite surfaces of a tile but in the inclined direction along its cut surface 39. Such a method of cutting is also possible depending upon the applications of tiles. It is noted that the means for adjusting the angle of the surface of the rotary blade 22 with respect to the slope of the inclined base is not limited to that illustrated in the figure.

Although the present invention was disclosed chiefly along the one embodiment of the present invention in the above description, the disclosure could be modified in part using well known techniques following the principle of the present invention. Various embodiments could be possible for the cutter rail, the slide mechanism of the movable supporter, and the height adjusting mechanism for the rotary blade for example.

1. A cutter apparatus for a flat plate building material comprising:
an inclined base having a slope;
a cutter including a rotatable blade for cutting a flat plate building material slipping down on the slope; and
cutter fixing means for fixing said cutter to dispose said rotary blade at a predetermined height from said slope.

2. A cutter apparatus for a flat plate building material according to claim 1 wherein said cutter fixing means comprises a cutter rail trained between the opposite ends of said slope perpendicularly to the direction of the inclination of said slope; a movable supporter movable along the cutter rail; and a cutter holder mounted on said movable supporter for supporting a casing of said cutter.

3. A cutter apparatus for a flat plate building material according to claim 2 wherein said cutter rail includes a rail groove, and said movable support section includes a fitting portion having a shape fitting to said rail groove.

4. A cutter apparatus for a flat plate building material according to claim 2 wherein said cutter rail includes a pair of rail rods, and said movable support portion includes a fitting portion having a pair of holes through which said pair of the rail rods pass.

5. A cutter apparatus for a flat plate building material according to any of claims 2 to 4 wherein it includes means for adjusting the mounting position of said cutter holder with respect to said movable support portion to change the height of said rotary blade from said slope.

6. A cutter apparatus for a flat plate building material according to claim 5 wherein it includes a side stopper extending between opposite ends of said slope in parallel to the direction of the inclination to bring said side stopper into contact with the side surface of said slipping-down flat plate building material.

7. A cutter apparatus for a flat plate building material according to claim 6 wherein said side stopper is movable perpendicularly to the direction of said inclination.

8. A cutter apparatus for a flat plate building material according to any of claims 2 to 7 wherein there is provided a slit extending in the direction of said inclination in the slope of said inclined base to receive a folded portion when said flat plate building material has the folded portion.

9. A cutter apparatus for a flat late building material according to any of claims 2 to 8 wherein there is provided a second inclination to permit one side of said inclined base to be lower than the other side of the same in the direction perpendicular to the direction of the inclination of said slope.

10. A cutter apparatus for a flat plate building material according to any of claims 2 to 9 wherein there is further provided means for adjusting the angle of the face of said rotary blade with respect to said slope.
